(19) United States
(12) Patent Application Publication
(10) Pub. No.: US 2022/0051192 A1
(43) Pub. Date: Feb. 17, 2022

(54) DOCUMENT, DRIVE AND PROCESS MANAGEMENT FOR CONTRACT OF THINGS AND DOCUMENT OF THINGS

(71) Applicant: SHELTERZOOM CORP., New York, NY (US)

(72) Inventors: Chao CHENG-SHORLAND, New York, NY (US); Amir Homayoun ALISHAHI, Staten Island, NY (US)

(21) Appl. No.: 17/312,535

(22) PCT Filed: Aug. 28, 2020
(86) PCT No.: PCT/US2020/048503

§ 371 Date: Jun. 10, 2021

Related U.S. Application Data
(60) Provisional application No. 62/893,329, filed on Aug. 29, 2019.

(51) Int. Cl. G06Q 10/10; G06F 16/93; G06F 16/176; G06F 16/13; G06F 21/62

(52) U.S. Cl. CPC G06Q 10/103; G06F 16/93; G06F 21/6218; G06F 16/137; G06F 16/176

(57) ABSTRACT

Disclosed herein are system, method, and computer program product embodiments for managing documents, drives and tokens using a blockchain. A smart drive system may facilitate the creation of a project data structure. The project data structure may indicate a sequence or flow of documents and/or document types. The smart drive system may also manage groups of documents and generate document and group tokens to manage access permissions. The smart drive system may also preserve received or completed documents using a blockchain. In some embodiments, the document may be a contract. The smart drive system may facilitate modifications to the document from other parties, which may represent counteroffers or a negotiation process. The smart drive system may also interconnect documents of a project data structure to create documents with pre-filled data.

### BACKGROUND

### Field

This field is generally related to document, folder and process tokenization, management, and creation using blockchain technology, their applications to create, deliver, disseminate and collaborate on confidential documents, as well as their applications to manage documents related to projects, processes, transactions, records, certifications, and/or other documents.

### Related Art

As individuals, businesses, and governments interact, parties often exchange many documents to accomplish projects or to complete transactions. These documents may include written specifications for a project or may be contractual obligations. For example, several documents may be needed to execute a transaction, such as a purchase of property, goods, or services. The documents may preserve contractual obligations or evidence the completion of a step in the transaction.

Similarly, when tracking the completion of a project, several documents may be needed to demonstrate the completion of each step. For example, for a construction project, a contract may be needed to begin the project while a specification document may describe formal metrics of the structure to be built. Another document may include a receipt indicating the purchase of the materials for the project. Additionally, a final acceptance document may be required that is signed by the parties of the project.

Managing this documentation may be difficult for several reasons. Typically, electronic document files are not structured or tied to the particular transaction or project. In this manner, data errors within the document files may create inconsistencies. Document management systems do not manage the content of the document files. Further, document management systems lack a flow of documentation to complete a transaction or project. This flow is important for tracking the status of a project and providing guidance for document management. This is especially true when multiple parties are involved with the transaction or project. Based on these issues, conventional file storage systems lack the ability to create dynamic and fit-for-purpose document structures corresponding to a process flow. They are merely a replication of a manual filing cabinet. Conventional files and folders are an antiquated technological concept that constraints and limits the growth of business and the world's e-Commerce in general.

### BRIEF SUMMARY

Disclosed herein are system, apparatus, device, method and/or computer program product embodiments, and/or combinations and sub-combinations thereof, for managing documents, drives and processes using blockchain technology.

In an embodiment, a smart drive system may facilitate and manage documents using document tokens, group or folder tokens, digital wallets, and a blockchain. The smart drive system may also use a project data structure to organize documents, document types, folders, and/or sub-folders into a sequence for completing a project, transaction, and/or process. The organization of these documents using the smart drive system provides a flow for the management of documents for completing a project. In some embodiments, the project data structure may be used to manage documents and/or a lifecycle of documents related to a “thing,” such as a person, property, animal, asset (e.g., boat, car, collectible artwork), and/or other objects. In this manner, the documents corresponding to the project or “thing” may be interconnected, which may provide a document of things or contract of things interconnectivity. In some embodiments, the smart drive system may manage different groupings of documents using group or folder tokens.

The smart drive system may receive and/or generate documents for completion. Upon receipt or completion of a document, the smart drive system may update the project data structure. The smart drive system may also update group or folder tokens corresponding to the project data structure. The smart drive system may then identify another document from the sequence for completion. In some embodiments, the smart drive system may also analyze common data values between received documents to aid in generating subsequent documents. By identifying patterns of data, the smart drive system may more quickly generate documents for completion of the project. Further, the smart drive system may maintain an interconnectedness between documents of the project to maintain consistency throughout the documents. The smart drive system may also store a hash of the documents and/or a hash of a group of documents on a blockchain to preserve the documents in an immutable manner. This may provide additional confidence that the one or more documents have been preserved and are free from tampering.

The smart drive system may operate in several contexts. For example, the smart drive system may aid in completing projects or transactions. These may include construction projects for example. A construction project may include a group of interrelated documents. The smart drive system may manage these documents, create documents for the project, and also prompt users to provide requisite documents. Similarly, the smart drive system may manage a merger or acquisition transaction by managing relevant documents related to due diligence and contracts. The smart drive system may also manage supply chain interactions with multiple parties. For example, the smart drive system may provide a “contract of things” between sellers, buyers, distributers, consumers, and/or other parties of a supply chain. In some embodiments, the smart drive system may manage a lifecycle of documents corresponding to a person, property, animal, asset (e.g., boat, car, collectible artwork), and/or other object.

### BRIEF DESCRIPTION OF THE DRAWINGS

The accompanying drawings are incorporated herein and form a part of the specification.

FIG. 1 depicts a block diagram of a document management environment with a smart drive system, according to some embodiments.

FIG. 2 depicts a flow diagram illustrating a communications flow for managing documents corresponding to a project or transaction, according to some embodiments.

FIG. 3 depicts a flowchart illustrating a method for creating a project data structure, according to some embodiments.

FIG. 4 depicts a flowchart illustrating a method for updating a project data structure, according to some embodiments.

FIG. 5 depicts a flowchart illustrating a method for generating a document template within a project data structure, according to some embodiments.

FIG. 6 depicts a flowchart illustrating a method for updating a project data structure depending on a document type, according to some embodiments.

FIG. 7 depicts a flowchart illustrating a method for propagating document data, according to some embodiments.

FIG. 8 depict a block diagram depicting group tokens and document tokens, according to some embodiments.

FIG. 9 depicts a flowchart illustrating a method for generating a group token, according to some embodiments.

FIG. 10 depicts an example computer system useful for implementing various embodiments.

In the drawings, like reference numbers generally indicate identical or similar elements. Additionally, generally, the left-most digit(s) of a reference number identifies the drawing in which the reference number first appears.

### DETAILED DESCRIPTION

Provided herein are system, apparatus, device, method and/or computer program product embodiments, and/or combinations and sub-combinations thereof, for managing documents using blockchain technology. The embodiments disclosed herein may facilitate the generation of a document by providing a front-end user interface while managing the document using a connected, associated, or related back-end system interfaced with a blockchain. The front-end may be a user interface such as a graphical user interface (GUI) that allows a user to manage a flow of documents. This flow of documents may correspond to a project or transaction. Similarly, one or more parties corresponding to the project or transaction may create, access, supply, and/or modify the documents corresponding to the flow.

Users may interact with a smart drive system to define a project data structure and/or a flow of documents and/or document types. The smart drive system may be a cloud-based platform and/or may be a software-as-a-service (SaaS) application that manages documents, document types, and/or projects. By defining a project data structure with a flow of documents and/or document types, the smart drive system may manage and organize documents to facilitate the completion of a project and/or a transaction. In some embodiments, the project data structure may identify a process and/or a lifecycle of documents. Further, by maintaining document templates, the smart drive system may facilitate the creation of documents for a particular flow. Upon completion and/or execution of the document, the smart drive system may indicate that a particular document has been completed and may identify a subsequent document in the flow for completion. The smart drive system may receive the document and/or verify a received document for indicating completion. The smart drive system may also generate a document for completion and identify when the generated document has been completed. Upon determining that a document has been supplied in a flow, the smart drive system may update the project data structure and may identify a subsequent document for completion.

In some embodiments, the smart drive may also use a smart folder structure to organize templates, documents, and/or contracts. This smart folder structure may correspond to the project data structure and may group documents. For example, a particular smart folder may group documents corresponding to a part of a transaction, negotiation, project, deal, and/or process flow. In some embodiments, the smart folder may organize interrelated and/or unrelated documents, entities, or elements. The project data structure may provide a flow and/or organization for one or more smart folders. The smart folders may also be nested into sub-folders.

The smart drive system may also use document tokens, group tokens, and/or folder tokens to manage documents, drives and processes. As will be further explained below, document tokens may be used to represent ownership and/or permissions corresponding to a document. A document token may be a non-fungible type of token to digitally represent a tokenized document such as record, certificate, document, agreement and contract, held by stakeholders with various levels of permissions. Similarly, a group or folder token may be a non-fungible type of token to digitally represent a tokenized folder or a structure which contains a hash of parent folder/group token ID(s), sub folder/group token ID(s), document token ID(s), folder owner, issue date and folder participants etc., held by stakeholders with various levels of permissions. The smart drive system may execute a hash algorithm on a group of documents to generate a group and/or folder token. The document token, group token, and/or folder token may be platform-agnostic. Further, the document token, group token, and/or folder token may be attached and/or detached from a project data structure. In some embodiments, using document tokens, group tokens, and/or folder token in the project data structure may provide a hierarchical structure, a folder structure, and/or a process management organization.

In some embodiments, the smart drive system may manage documents using a blockchain interface. For example, on either a public or private blockchain, documents may be published and/or tracked. The smart drive system may calculate a hash of a document and/or a group of documents and store the hash on the blockchain. In some embodiments, the smart drive system may execute code on the blockchain using smart contract functions. The publication to a blockchain may provide security and trust that completed documents are immutable. Further, distributed ledger technology may provide a streamlined manner of tracking modifications to documents and presenting these modifications to parties communicating and/or editing a document. As will be further described below, the embodiments described herein further provide faster and more efficient back-end processing for blockchain operations. In particular, the use of asynchronous calls to the blockchain may provide increased speed and may avoid delays related to blockchain transaction times.

The embodiments described herein may further be used in contract negotiations to provide a streamlined contract platform for tracking and viewing offers and counteroffers. For example, the smart drive system may generate a multi-party contract as a document in a project data structure. In some embodiments, the contract may be an offers to purchase goods, services, property, insurance, and/or other contractual obligations. The smart drive system may also facilitate counteroffers and/or negotiations of contractual terms and/or manage digital signatures representing an acceptance of an offer. In this manner, the smart drive system may facilitate the execution of a contract document. This execution may be tracked as part of the flow of a project data structure. These contractual documents may be managed by a blockchain, which allows parties to operate in a more trusted manner. The smart drive system may streamline a negotiation process that preserves confidentiality while maintaining a high degree of trust.

In this manner, the smart drive system may manage a flow of documents to aid in facilitating projects, transactions, and/or process flows. The smart drive system may receive and/or organize documents based on a project data structure. The smart drive system may also generate documents and/or interconnect document data to aid in maintaining consistency. This document management configuration aids in reducing the number of user interactions and computational transactions while also reducing network traffic.

Various embodiments of these features will now be discussed with respect to the corresponding figures.

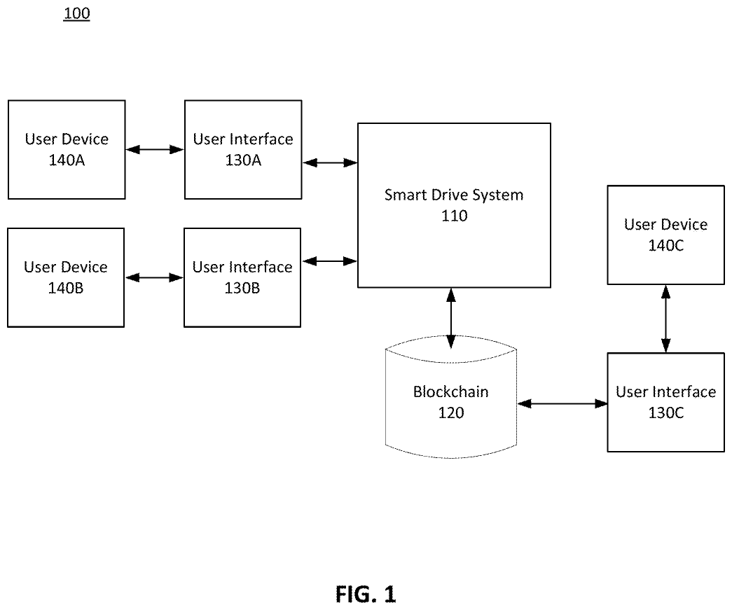

FIG. 1 depicts a block diagram of a document management environment 100 with a smart drive system 110, according to some embodiments. In addition to smart drive system 110, document management environment 100 may include blockchain 120, user interfaces 130, and/or user devices 140. Smart drive system 110 may include one or more servers and/or databases that may instantiate user interfaces 130A-130B for user devices 140A-140B. Smart drive system 110 may include object storage, a web service interface, storage for Internet applications, and/or cloud computing and/or storage. Smart drive system 110 may be a cloud-based platform and/or may be a software-as-a-service (SaaS) application that manages documents, document types, and/or projects. In some embodiments, smart drive system 110 may use a peer-to-peer network and/or protocol for storing and/or sharing data in a distributed file system. For example, smart drive system 110 may use content-addressing to uniquely identify files in a global namespace to network user devices 140. In some embodiments, smart drive system 110 may use the InterPlanetary File System (IPFS) protocol and/or servers such as Amazon S3®.

Smart drive system 110 may include an interface with blockchain 120. Blockchain 120 may be a private or public blockchain. Smart drive system 110 may use one or more smart contract functions to interface and/or publish data to blockchain 120. The smart contract functions may include protocols to digitally facilitate, verify, and/or enforce transactions. The transactions may be trackable and irreversible. As will be further described below, smart drive system 110 may interface with blockchain 120 to store data representing documents and/or modifications to documents. This data may include a cryptographic hash of a document and/or a link to a human-readable representation of the document. Smart drive system 110 may use this storage to ensure immutability when tracking a flow of documents corresponding to a project data structure.

In some embodiments, smart drive system 110 may also manage document, group, and/or folder tokens, which may also be managed using blockchain 120. As will be further explained below, the document tokens may represent ownership and/or permissions for documents and/or document modifications. Group or folder tokens corresponding to a smart folder organization may organize documents and/or document tokens into portions of a project data structure. For example, document tokens may include metadata corresponding to folder tokens indicating a folder structure for the documents. Different users may have different permissions depending on digital wallets corresponding to the user having a particular document token, group token, and/or folder token.

In some embodiments, document tokens may correspond to different group tokens and/or folder tokens. If a document token corresponds to multiple group tokens and/or folder tokens, smart drive system 110 may perform deduplication and avoid the storage of redundant copies of the underlying document data. In this manner, a user may apply a document token to different project data structures. Further, the user may associate a document token with different group and/or folder tokens in the same or different project data structures. For example, a user's driver's license may have a document token corresponding to a folder token for a “Personal Identity” folder. This folder may be a project data structure corresponding to management of the user's personal records. The user may define other project data structures, such as a “Fishing License Application” folder or a “Travel Visa Application” folder having the document token corresponding to the driver's license. In some embodiments, a document token may correspond to a pre-qualification for purchasing a house. A realtor may place this document token into several property folders for consideration and preparation to make an offer. In this manner, the document token may be a “single source of truth” as maintained by blockchain 120 for multiple groups.

When defining a project data structure and/or generating a group or folder token corresponding to the project data structure, smart drive system 110 may identify several metadata fields. For example, the metadata may include a type for the project data structure, such as a Transaction, Project, Negotiation, Deal, Planning, Procurement, Other Process, Templates, Documents, Record Keeping, Other. The metadata may also allow a sub-type designation such as Real Estate, Development, Technology, M&A, Financial, Supply Chain, Procurement Recruitment, HR, Other. The metadata may allow a user to designate whether to enable automatic population of data. The metadata may also include permissions data as well as identification data including a title, description, date of creation, creator/owner data, role of the creator, a state (e.g., draft, in progress, complete), and/or other custom fields.

In some embodiments, a group or folder token may provide expanded security when attached to structures, hierarchies, document elements or fields, templates, and/or documents. For example, the group or folder token may allow for the designation of roles for permissions. These roles may include an owner or creator of a group token; a manager assigned by the owner who may manage the group token (e.g., manage users and permissions, edit metadata, configure contract execution rules, and/or delete the project); an editor of content; an acknowledger who may acknowledge receipt of a group token; a viewer of the content; and/or a shared viewer who may share permissions. In some embodiments, invitees may have the same permissions as the inviter. In some embodiments, an invited user may already have different permissions, however, which may or may not be overwritten.

In some embodiments, users may have different permissions for different documents within a group and/or project data structure. For example, John may have an Edit permission for the Group L1, but may only have an Acknowledge permission for doc1; a Shared View permission for doc2; and a Comment permission for sub-Group B. When John invites Mary to Group L1 with the Edit permission, smart drive system 110 may automatically assign Mary with John's same permissions for doc1, doc2 and sub-Group B respectively. In this manner smart drive system 110 may prevent an inviter from providing permissions that are beyond the inviter's own permissions.

As previously explained, to generate a group or folder token, a user may define a project data structure. In some embodiments, the user may use a GUI to select a template group. For example, a real estate transaction group may include document templates used for listings, sales, and closing documents for a state. A predefined template may provide these documents and save users of the industry time while aiding with compliance for state rules and regulations. Similarly, a project data structure may be used by a human resources onboarding process. The documents may include company policies, directives for new employee to acknowledge, and/or agreements for signature. While templates for project data structures may exist, users may also modify these templates and/or adjust the documents in the project data structure. For example, documents may be added, re-ordered, and/or removed. In some embodiments, rules may be re-defined such as for smart contracts. Users may also modify the grouping of documents. Similarly, users may modify the content of a document.

By managing the document tokens, group tokens, and/or folder tokens using a project data structure, smart drive system 110 may manage a flow and/or sequence of documents. For example, smart drive system 110 may maintain a project data structure that organizes documents and/or folders with documents. In some embodiments, smart drive system 110 may organize multiple documents and/or folders of documents into a flow or sequence to aid in the completion of a project and/or a transaction. The folders may also be nested into sub-folders. To initialize this flow, a user may create a project data structure and/or select a project data structure from a template. In some embodiments, the project data structure may not include a sequence. For example, the project data structure may allow for the submission of documents corresponding to a list of documents. In some embodiments, this listing may not require an ordering in the submission of documents.

The user may interface with smart drive system 110 via a front-end user interface 130. Smart drive system 110 may provide a front-end user interface 130 to allow users to supply, create, manage, edit, and/or modify documents. Further, user interface 130 may allow users to manage a project data structure, corresponding documents, and/or a sequence of documents corresponding to the project data structure. User interface 130 may be a graphical user interface (GUI) that may be accessed and/or displayed on a user device 140. User device 140 may be a computer, laptop, tablet, phone, and/or other device that may access the Internet and/or display a user interface 130. User interface 130 may include an application programming interface (API) to provide communications between user device 140 and smart drive system 110.

As will be further explained below, smart drive system 110 may provide a front-end GUI including GUI elements allowing a user to create a project data structure, identify a document and/or document type flow or sequence corresponding to the project data structure, submit document files, create documents, modify documents, manage document permissions, manage document modifications from other parties, manage a digital wallet, manage user account information and/or account roles, and/or other document interactions. This GUI may be displayed on user device 140 using user interface 130. In some embodiments, smart drive system 110 may facilitate the incorporation of GUI elements into web pages not managed by smart drive system 110 to allow users to access the operations provided by smart drive system 110. For example, smart drive system 110 may provide a web widget that may be incorporated, integrated, or overlaid onto other web pages to provide similar project and/or document functionality.

For example, smart drive system 110 may generate an icon and/or button allowing a user to create a project data structure. The user may interact with the icon or button via a selection, press, or click on a GUI. In response to this interaction, smart drive system 110 may generate a project creation GUI element displayed on the GUI. The project creation GUI element may display document type options and/or folder options for managing the documents corresponding to the project. The project may represent, for example, a project, transaction, and/or process for completion. By interacting with the project creation GUI element, a user may identify the particular documents and/or document types for the project.

In some embodiments, the user may select from a list of available project templates to create a project data structure. A project template may include a list of documents and/or folders. The project template may arrange the documents and/or folders into a flow or sequence. The user may adjust this flow or sequence if desired by interacting with the project creation GUI. For example, the project creation GUI may include example projects and/or transaction templates. These templates may include, for example, construction projects, real estate transactions, supply chain management projects, e-commerce transactions, personal information management, and/or other projects and transactions. By selecting a project template, smart drive system 110 may generate a list of documents, document types, and/or folders for completion of the project. The user may add, remove, modify, and/or re-arrange these documents in the sequence. As will be further explained below, users may supply and/or create the listed documents and/or document types in order to complete the corresponding project. Smart drive system 110 may track and/or verify the document submissions. Smart drive system 110 may further aid in creating documents when identifying a pattern of common document data across the documents.

Returning to the project creation GUI, smart drive system 110 may also allow a user to create a project data structure by specifying documents, document types, and/or folders. The user may specify a document by selecting from a list of document templates and/or by entering a name of the document. Upon selecting multiple documents and/or document templates, the user may arrange the documents and/or document templates into a flow or sequence. For example, a user may identify a project as a construction of a new road or highway. The user may then specify several documents for the completion of this project. These documents may include a contract with a construction company, a specifications document for the road, a receipt for the cost of materials, an inspection document identifying satisfactory construction, and/or other documents required for the completion of the project. The user may then group these documents into folders and/or arrange the documents into a flow or sequence. This arrangement may provide an interconnection between the documents and/or may allow smart drive system 110 to analyze and detect common data within the documents. With this data, smart drive system 110 may generate and/or populate subsequent documents with the common data. This common data may be, for example, names, addresses, prices, amounts, and/or other data fields common between documents. In this manner, the flow or sequence of a project may aid in the automatic generation of other documents.

In some embodiments, the project data structure may not include a sequence. For example, the project data structure may include a grouping of documents which may be completed. Completion and/or submission of documents within a group of documents may not include a particular ordering. In some embodiments, the group may be the whole project data structure or may be a portion of a project data structure. For example, when the group includes the whole data structure, no sequence may be defined. When the group is a portion of the project data structure, the group may be sequenced with other documents and/or groups. Documents within the group may not be sequenced. In some embodiments, access to a group may depend on the completion of previously defined documents and/or other groups.

Upon creating a project data structure and/or a flow or sequence of documents, a user may submit documents to smart drive system 110. The submission of documents may indicate a completion of a step in a project or transaction. For example, the project data structure may indicate a particular document or document type required. The user may upload a document file using user device 140 to submit the indicate document or document type. Upon receiving the document, smart drive system 110 may indicate that the document and/or step of the project has been completed. Smart drive system 110 may then identify a subsequent document for the user to provide to continue the project.

In some embodiments, smart drive system 110 may generate a document for the user to complete as part of a project data structure. For example, smart drive system 110 may include templates of documents and/or contract documents. A law firm may create these templates. Smart drive system 110 may provide these templates for purchase and for use by a user. These templates may include invoices, contracts for goods and/or services, rental documents, lease documents, and/or other documents corresponding to a project or transaction. In some embodiments, the user may complete the document by providing information and/or filling fields of information corresponding to the document. Smart drive system 110 may detect when a party has completed a document. For example, when the user has completed the requisite fields and/or when the user has indicated that the document is complete. For example, the document may be an invoice for the purchase of construction materials. Upon supplying the relevant information such as material type, price, quantity, and buyer information, smart drive system 110 may indicate that the invoice has been completed.

In some embodiments, the document generated by smart drive system 110 may be a contract and/or a document corresponding to multiple parties. For example, smart drive system 110 may facilitate an offer and acceptance or negotiation process to manage the completion of a document by multiple parties. This negotiation process may include one or more rounds of offers and counteroffers between parties. A user may specify conditions and/or obligations using smart drive system 110 to generate a contractual document for execution by another user. Smart drive system 110 may deliver this contract document to the other party to notify the party of the pending contract. For example, smart drive system 110 may provide a notification via electronic mail or via a push notification to a user device 140 corresponding to the user. The parties may digitally negotiate using smart drive system 110 and modify different portions of a document. For example, the parties may negotiate different contractual terms and/or obligations. Smart drive system 110 may use a tokenization process to manage different portions of a document and/or to manage counteroffers. This negotiation and/or document editing may also occur between multiple parties.

Upon completion of the editing, parties may provide digital signatures indicating an acceptance of the terms. When the document has been completed, smart drive system 110 may update the project data structure to reflect a completion of the document. Smart drive system 110 may then identify a next document. In some embodiments, smart drive system 110 may analyze the document to aid in pre-filling subsequent documents in the project data structure. For example, smart drive system 110 may identify party names, projects specifications, prices, quantities, dates, addresses, and/or other data to pre-fill into other documents corresponding to the project data structure. Smart drive system 110 may analyze fillable forms to extract this data. In some embodiments, smart drive system 110 may use machine learning, artificial intelligence, deep learning, neural networks, and/or other machine learning techniques to identify patterns of common data among the received or created documents. In this manner, smart drive system 110 may provide interconnectivity between documents. This interconnectivity may be especially relevant to the project and aiding to more quickly generate documents using data common to the project.

In some embodiments, smart drive system 110 may apply this intelligence to identify elements and/or fields of a document. The identification of the fields and/or elements may aid in the interconnectivity of the documents managed by smart drive system 110. For example, as previously explained, the identification of these values may aid in pre-filling fields of other documents. By extracting these values, smart drive system 110 may transform unstructured data and/or document files into structure data. Smart drive system 110 may identify values corresponding to data fields. Smart drive system 110 may then populate other documents having the same data fields with these values. This structuring may provide interconnectivity across a project, transaction, process, records, and/or lifecycle of documents. In some embodiments, smart drive system 110 may manage these documents for a “thing” such as a person, property, animal, asset (e.g., boat, car, collectible artwork), and/or other objects. In this manner, the documents corresponding to the “thing” may be interconnected, which may provide a document of things or contract of things interconnectivity.

In some embodiments, smart drive system 110 may also identify documents related to records and/or certificates. A project data structure may indicate that a record or certificate is a document required for completion of a document or transaction. In some embodiments, a user may create a personal project and/or a personal project data structure used for managing personal documents. For example, a user may use smart drive system 110 to manage and/or preserve documents corresponding to the user using blockchain 120. In this case, the documents identified in the project data structure may correspond to the user. These documents may include certificates such as a birth certificate, marriage certificate, driver's license, college degree, and/or other documents which a user may deem as being official. In some embodiments, the documents may include medical records. The preservation on blockchain 120 may indicate that the document is authentic. For example, a university, government agency, and/or other institutions may preserve documents on blockchain 120 related to a user to confirm the authenticity of the document and/or that a particular certificate was actually issued by the institution. Smart drive system 110 may manage document tokens related to these certificates and/or transmit document tokens to digital wallets corresponding to a user. The user may be able to use smart drive system 110 to track, view, and/or manage documents throughout a user's lifetime. Smart drive system 110 may provide a repository for these documents while maintaining confidentiality and providing verifiable proof of authenticity.

In some embodiments, this project data structure may also be applied to other “things” such as property or assets. In this manner, smart drive system 110 may manage a lifecycle of documents related to different objects. If ownership of a particular object changes (e.g., via a transaction), the project data structure may operate as a repository for the document related to the object. Ownership and/or permissions related to the project data structure may also change.

In some embodiments, a user may import preserved documents into another project data structure to add the document to that project. For example, the document may be personal information or a certificate. Similarly, if a document is common to multiple projects, that document may be referenced by the projects. In some embodiments, smart drive system 110 may store the document with references to multiple projects rather than replicating the document multiple times. This may reduce the storage required as well as network bandwidth usage by not requiring a user to re-upload documents already stored by smart drive system 110.

Upon receiving and/or completing a document, smart drive system 110 may store the document using blockchain 120. As will be further explained below, smart drive system 110 may store an encrypted version of the document and/or create a link to the encrypted version of the document. Smart drive system 110 may also generate a cryptographic hash of the document. Smart drive system 110 may store the hash of the document on blockchain 120. Using this information along with other information such as an owner identification and/or other metadata, smart drive system 110 may create a document token corresponding to the document. The document token may represent ownership of the document and/or may be transmitted to a digital wallet corresponding to the user. Smart drive system 110 may use the document token in future operations to determine access and/or modification permissions. In some embodiments, smart drive system 110 may transmit the document token to another party to allow the other party to access and/or modify the document. For example, the document token may indicate that a buying party may modify the document with a digital signature to accept a contract document.

Smart drive system 110 may manage the document using blockchain 120. For example, smart drive system 110 may publish the cryptographic hash of the document and/or the link to the encrypted version of the document using smart contract functions. The document may be encrypted using a key corresponding to the user and/or administrator of the porjet. Publishing the document data onto blockchain 120 may preserve the trustworthiness of the document and the legitimacy of the offer and/or content. For example, the immutable nature of blockchain 120 may protect against unauthorized document modifications or tampering. Further, the cryptographic hash may preserve privacy and may prevent other users of the blockchain 120 from viewing confidential information. For example, user device 140C may be utilizing a separate user interface 130C to access blockchain 120 separately from token server system 110. The encryption may prevent user device 140C from viewing the confidential information stored on blockchain 120.

Based on the publishing of documents to blockchain 120, smart drive system 110 may manage documents corresponding to a project as well as preserve confidence corresponding to the documents. In this manner, smart drive system 110 may aid in project and/or transaction completion by managing and preserving relevant documents. This management and preservation also allows for document interconnectivity to aid in generating documents based on documents submitted by a user. In this manner, smart drive system 110 provides a project management tool for preserving a sequence of documents as well as a process for generating new documents corresponding to a project or transaction.

Other functions and/or operations of smart drive system 110 will now be further described with reference to the other figures of this disclosure.

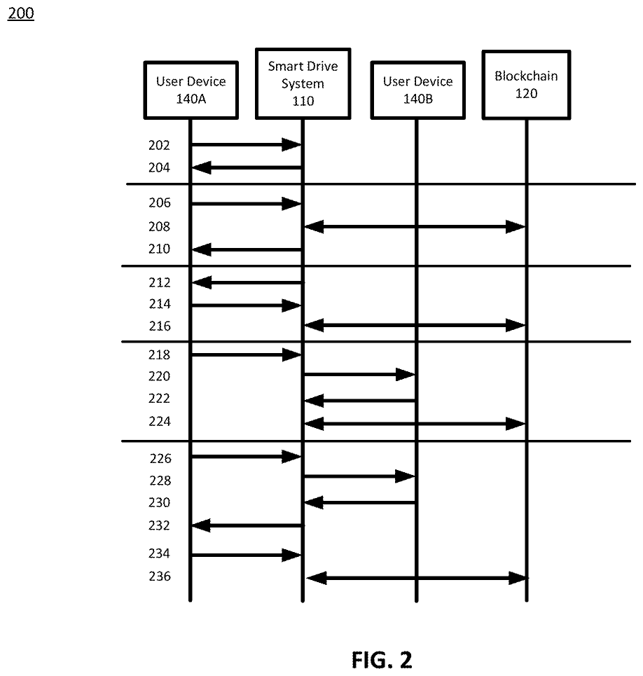

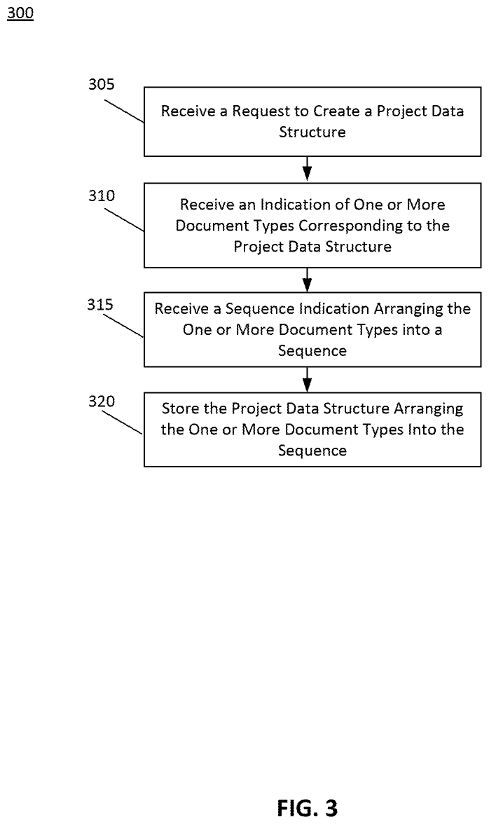

FIG. 2 depicts a flow diagram illustrating a communications flow 200 for managing documents corresponding to a project or transaction, according to some embodiments. Communications flow 200 includes interactions between user device 140A, smart drive system 110, user device 140B, and/or blockchain 120. Communications flow 200 describes an embodiment for creating a project data structure and/or supplying documents to complete a project. The processes described with respect to communications flow 200 are further described with reference to FIGS. 3 through 9.

Elements 202 and 204 of communications flow 200 depict the exchange of messages to create a project data structure. At 202 and 204, user device 140A may exchange messages with smart drive system 110 to create a project data structure. For example, a user may interact with a project creation GUI displayed on user device 140A to identify a project. Using user device 140A, the user may select from possible project templates. In some embodiments, the user may specify particular documents and/or document types for the project. The user may specify an arrangement or flow of documents corresponding to the project. In response to commands exchanged between user device 140A and smart drive system 110, smart drive system 110 may define a project data structure indicating a list of documents, document types, and/or folders with a specific arrangement or flow.

Elements 206, 208, and 210 of communications flow 200 depict the submission of a document from user device 140A to smart drive system 110. In response to identifying a project data structure, user device 140A may submit a document to fulfill an element of the project. In some embodiments, this document may be the next in a sequence of documents. Smart drive system 110 may prompt user device 140A via a GUI display indicating the document to be submitted. User device 140A may submit the document via an upload to a server of smart drive system 110. In some embodiments, this submission may occur via a message such as an email to a designated address of the smart drive system 110. In some embodiments, if user device 140A provides access to a cloud computing platform, which also includes access to smart drive system 110, the user may select a document within the cloud computing platform to submit. In this manner, the user may designate a document file via the cloud computing platform.

Upon receiving the document submission, smart drive system 110 may publish the document to blockchain 120. As previously explained, smart drive system 110 may hash and/or encrypt the document prior to publishing the document to blockchain 120. In some embodiments, smart drive system 110 may analyze the contents of the document to extract data for generating new documents. For example, smart drive system 110 may compare the content of the document to previously stored documents. Smart drive system 110 may similarly identify fields and/or data values corresponding to the fields to transform unstructured data into structured data. At 210, smart drive system 110 may indicate to user device 140A that the document has been successfully submitted. Smart drive system 110 may also indicate a subsequent document and/or document type for a user to supply.

Elements 212, 214, and 216 of communications flow 200 depict the generation of a document by smart drive system 110. In response to identifying a project data structure, smart drive system 110 may identify that possibility of creating a document template at 212. Smart drive system 110 may indicate this possibility to user device 140A via a GUI display. A user wishing to create the document using smart drive system 110 may indicate this desire by interacting with the GUI. At 214, the user may provide additional information to complete the document. For example, the user may provide data by filling-in fields of a document. In some embodiments, the user may edit the text of a document template. Upon completion of the document, smart drive system 110 may provide an indication and/or update the project data structure. At 216, smart drive system 110 may publish the created document to blockchain 120. As previously explained, smart drive system 110 may hash and/or encrypt the document prior to publishing the document to blockchain 120.

Elements 218, 220, 222, and 224 of communications flow 200 depict the completion of a document involving multiple parties. At 218, user device 140A may indicate the submission and/or creation of a document to smart drive system 110. User device 140A may indicate a document for completion by user device 140B. In this case, at 220, smart drive system 110 may notify user device 140B for user device 140B to complete the document. For example, user device 140B may provide additional information, data, and/or modifications to the document at 222 to complete the document. The smart drive system 110 may update the project data structure to indicate a completion of the document by user device 140B. As previously explained, smart drive system 110 may hash and/or encrypt the document prior to publishing the document to blockchain 120.

Elements 226, 228, 230, 232, 234, and 236 of communications flow 200 depict the negotiation and completion of a document involving multiple parties. The document may be, for example, a contract. User device 140A may submit and/or create a contract document at 226. For example, user device 140A may specify contract terms and/or identify the parties to the contract. At 228, smart drive system 110 may notify user device 140B for user device 140B to execute the contract or to complete the document. At 230, user device 140B may further modify the document or complete the document by providing additional information. For example, user device 140B may alter a term of the contract using a GUI provided by smart drive system 110. Upon identifying the modification, smart drive system 110 may notify user device 140A at 232. Smart drive system 110 may update the GUI displayed on user device 140A to identify the modification. In the case where user device 140A has accepted the modifications and has indicated an acceptance at 234, smart drive system 110 may update the project data structure to indicate a completion of the document. At 236, smart drive system 110 may publish the completed document to blockchain 120. As previously explained, smart drive system 110 may hash and/or encrypt the document prior to publishing the document to blockchain 120.

Based on communications flow 200, smart drive system 110 may identify the documents required to satisfy a project data structure. Smart drive system 110 may facilitate the management and preservation of these documents using blockchain 120. Smart drive system 110 not only allows user device 140A to submit or upload documents, but also facilitates the creation of documents. When creating documents, smart drive system 110 may also pre-fill data based on documents previously submitted and/or completed. This interconnectedness between documents may allow for the more efficiency creation and completion of documents for a project data structure.

FIG. 3 depicts a flowchart illustrating a method 300 for creating a project data structure, according to some embodiments. Method 300 shall be described with reference to FIG. 1; however, method 300 is not limited to that example embodiment.

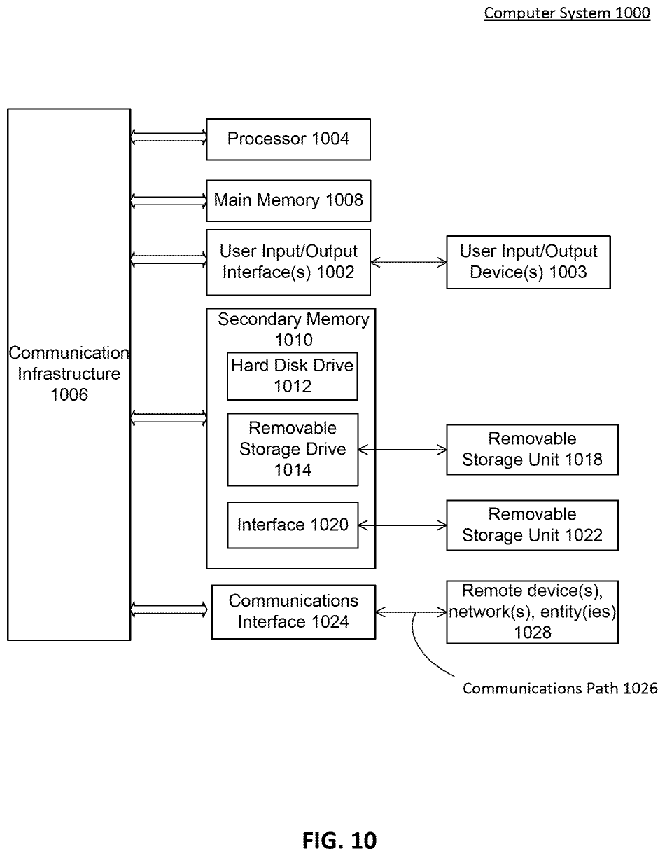

In an embodiment, smart drive system 110 may facilitate the generation of a project data structure. The project data structure may indicate a sequence of documents, document types, and/or folders organizing documents. The project data structure may aid in providing a sequence of documents for completion of a project or transaction. While method 300 is described with reference to smart drive system 110, method 300 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 3, as will be understood by a person of ordinary skill in the art.

At 305, smart drive system 110 may receive a request to create a project data structure. For example, a user device 140 may provide a command via a user interface 130 to smart drive system 110. A user may navigate a GUI to indicate the creation of a project data structure. This project data structure may correspond to a project, transaction, and/or process. The project data structure may be metadata, which indicates list of documents, document types, folders, and/or a sequence of documents, document types, or folders. In some embodiments, the project data structure may represent a flow where a user supplies a document earlier in the sequence before supplying a document later in the sequence. In some embodiments, the project data structure may allow a user to provide documents independent of the defined flow. For example, if the project data structure includes a folder, a user may submit documents corresponding to the defined folder independent of a sequence within the folder.

At 310, smart drive system 110 may receive an indication of one or more document types corresponding to the project data structure. A user using a user device 140 may define a set of documents and/or document types when creating the project data structure. This set of documents may indicate the documents for completion of the project or transaction. In some embodiments, a selection of a project data structure template may derive the one or more document types. The documents and/or document types may refer to specific documents and/or a category of acceptable documents. For example, a document type may specify a category such as a “contract” while a specific document may be a “letter of intent.” In some embodiments, a document type may be a categorical designation and/or may refer to a specific document.

At 315, smart drive system 110 may receive a sequence indication arranging the one or more document types into a sequence. This sequence may be a flow as explained above. In some embodiments, the documents may be organized into folders and/or folders may be organized into a sequence. As previously explained, the sequence and/or flow may define a sequence of documents. Submission and/or completion of a document in the flow may cause smart drive system 110 to identify a subsequent document in the flow for completion.

At 320, smart drive system 110 may store the project data structure arranging the one or more document types into the sequence. Smart drive system 110 may store this project data structure in a database. Smart drive system 110 may associate this project data structure with one or more user accounts so that the user accounts may provide the documents specified by the project data structure.

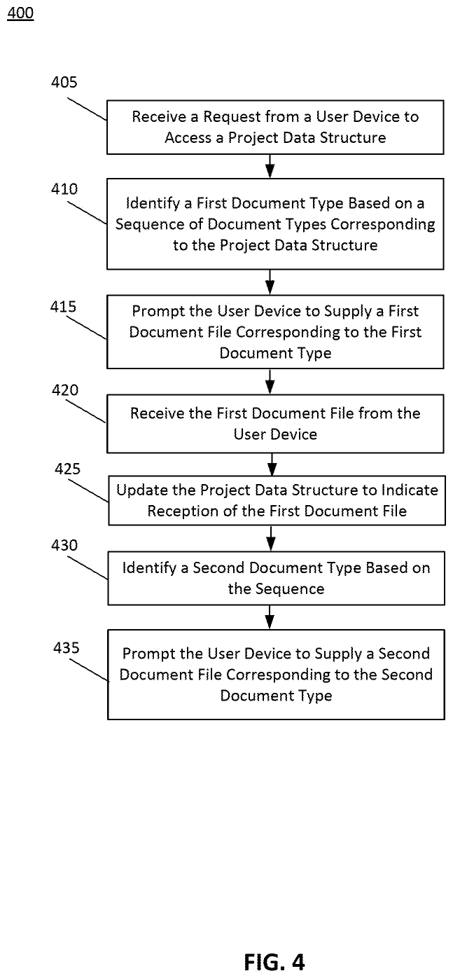

FIG. 4 depicts a flowchart illustrating a method 400 for updating a project data structure, according to some embodiments. Method 400 shall be described with reference to FIG. 1; however, method 400 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 400 is described with reference to smart drive system 110, method 400 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 4, as will be understood by a person of ordinary skill in the art.

At 405, smart drive system 110 may receive a request from a user device 140 to access a project data structure. This project data structure may have been previously defined with a sequence or flow of one or more documents and/or document types. Smart drive system 110 may receive the request via an interaction with a GUI.

At 410, smart drive system 110 may identify a first document type based on a sequence of document types corresponding to the project data structure. If no documents have been previously submitted for this project data structure, the first document type may be the first in the sequence. If documents have been previously submitted or completed, the first document type may be a following document type in the sequence. As previously explained, the document type may be a broad category of documents and/or may refer to a specific document. The specificity of the document may be variable.

At 415, smart drive system 110 may prompt the user device 140 to supply a first document file corresponding to the first document type. This prompt may be a display on a GUI displayed on the user device 140. In some embodiments, this prompt may be a notification and/or message to the user requesting the submission of the first document file. The prompt may vary depending on the specificity of the first document type. For example, if the first document type identifies a broad category, such as an “Invoice,” the prompt may reflect the broad category. In some embodiments, the first document type may be specific, such as “Invoice from XYZ Construction Co.” In this case, the prompt may be more specific.

At 420, smart drive system 110 may receive the first document file from the user device 140. User device 140 may upload the first document file to smart drive system 110. In some embodiments, in a cloud system, user device 140 may designate the first document file over a network. Upon receiving the first document file, smart drive system 110 may perform a verification to determine whether the first document file satisfies the first document type indicated by the project data structure. For example, smart drive system 110 may analyze metadata and/or content of the first document file to determine whether a satisfactory document has been supplied. Smart drive system 110 may identify fields of content within the document to determine whether the fields match expected content. In some embodiments, smart drive system 110 may notify an administrator of the project data structure to review the supplied first document file and to determine whether it is satisfactory.

At 425, smart drive system 110 may update the project data structure to indicate reception of the first document file. In some embodiments, this update may occur in response to verifying that the first document file satisfies the first document type. Updating the project data structure may include marking the submission of the first document type. In this manner, when accessing a GUI to view the documents of the project data structure, a user may see an indication that the document has been submitted. The user may interact with the GUI to view the document. In some embodiments, smart drive 110 may also preserve the received document file by publishing the document to blockchain 120 as previously discussed.

At 430, smart drive system 110 may identify a second document type based on the sequence. The second document type may be a subsequent document type after submission of the first document type. In some embodiments, smart drive system 110 may unlock the ability to submit the second document type in response to receiving the submission of the first document type. In this manner, smart drive system 110 may control the flow and/or sequence of the submitted documents. In some embodiments, a user may be permitted to submit multiple different document types independent of the sequencing. For example, if the sequence includes a folder, document types listed in the folder may be submitted independent of the sequence of their listing. In some embodiments, the folder may be arranged in sequence with other document types to further control the sequencing.

At 435, smart drive system 110 may prompt the user device 140 to supply a second document file corresponding to the second document type. This prompt may be similar to 415. If the second document file completes the sequence, smart drive system 110 may indicate the completion of the project data structure. In this manner, smart drive system 110 may preserve the documents corresponding to the project data structure while facilitating the reception of documents to complete the project, transaction, or process.

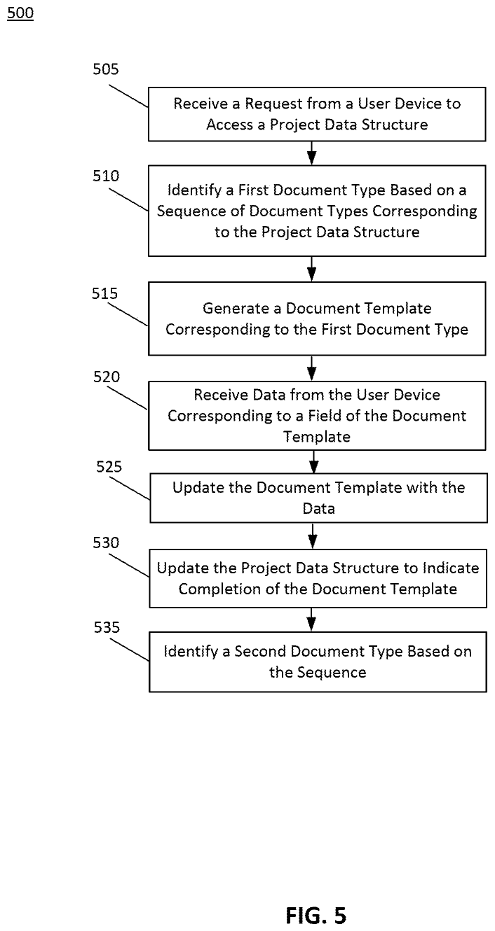

FIG. 5 depicts a flowchart illustrating a method 500 for generating a document template within a project data structure, according to some embodiments. Method 500 shall be described with reference to FIG. 1; however, method 500 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 500 is described with reference to smart drive system 110, method 500 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 5, as will be understood by a person of ordinary skill in the art.

At 505, smart drive system 110 may receive a request from a user device 140 to access a project data structure. This project data structure may have been previously defined with a sequence or flow of one or more documents and/or document types. Smart drive system 110 may receive the request via an interaction with a GUI.

At 510, smart drive system 110 may identify a first document type based on a sequence of document types corresponding to the project data structure. If no documents have been previously submitted for this project data structure, the first document type may be the first in the sequence. If documents have been previously submitted or completed, the first document type may be a following document type in the sequence. As previously explained, the document type may be a broad category of documents and/or may refer to a specific document. The specificity of the document may be variable.

At 515, smart drive system 110 may generate a document template corresponding to the first document type. The document template may be a fillable and/or editable document corresponding to the first document type. Using the document template, a user may supply data and/or information to complete the document. At 520, smart drive system 110 may receive data from the user device 140 corresponding a field of the document template. At 525, smart drive system 110 may update the document template with the data. The user may interactively supply data to complete the document. In some embodiments, smart drive system 110 may pre-fill data in the document template based on an analysis of previously supplied documents. This data may be determined based on an analysis of previously supplied data. The user may supply additional data and/or modify existing data to complete the document.

In some embodiments, the document may require input from multiple parties. The document may be, for example, a contract. The parties may modify the document and/or negotiate terms. In this case, smart drive system 110 may facilitate the negotiations and/or the execution of the contracts. For example, smart drive system 110 may receive a modification of the document template from a second user device. Smart device system 110 may notify the first user device of the modification. Smart drive system 110 may also provide different response options such as accepting the modification, rejecting the modification, counteroffering, and/or other responses. If the modification is rejected or the first user device supplies a counteroffer, smart drive system 110 may notify the second user device of this response. The parties may continue negotiations which smart drive system 110 may facilitate. If the modification is accepted, smart drive system 110 may also notify the second user device and/or may update the project data structure at 530 to indicate the acceptance.

At 530, smart drive system 110 may update the project data structure to indicate completion of the document template. In some embodiments, this update may occur in response to verifying the data supplied. Updating the project data structure may include marking the completion of the first document type. In this manner, when accessing a GUI to view the documents of the project data structure, a user may see an indication that the document has been completed. The user may interact with the GUI to view the document. In some embodiments, smart drive 110 may also preserve the completed document file by publishing the document to blockchain 120 as previously discussed.

At 535, smart drive system 110 may identify a second document type based on the sequence. The second document type may be a subsequent document type after completion of the first document type. In some embodiments, smart drive system 110 may unlock the ability to submit the second document type in response to completing the first document type. In this manner, smart drive system 110 may control the flow and/or sequence of the completed documents. In some embodiments, a user may be permitted to complete multiple different document types independent of the sequencing. For example, if the sequence includes a folder, document types listed in the folder may be completed independent of the sequence of their listing. In some embodiments, the folder may be arranged in sequence with other document types to further control the sequencing.

Smart drive system 110 may also prompt the user device 140 to complete a second document template corresponding to the second document type. The user may complete the document in a manner similar to 520. Smart drive system 110 may also pre-fill common data in the second document template. If the second document template completes the sequence, smart drive system 110 may indicate the completion of the project data structure. In this manner, smart drive system 110 may preserve the documents corresponding to the project data structure while facilitating the completion of documents to complete the project, transaction, or process.

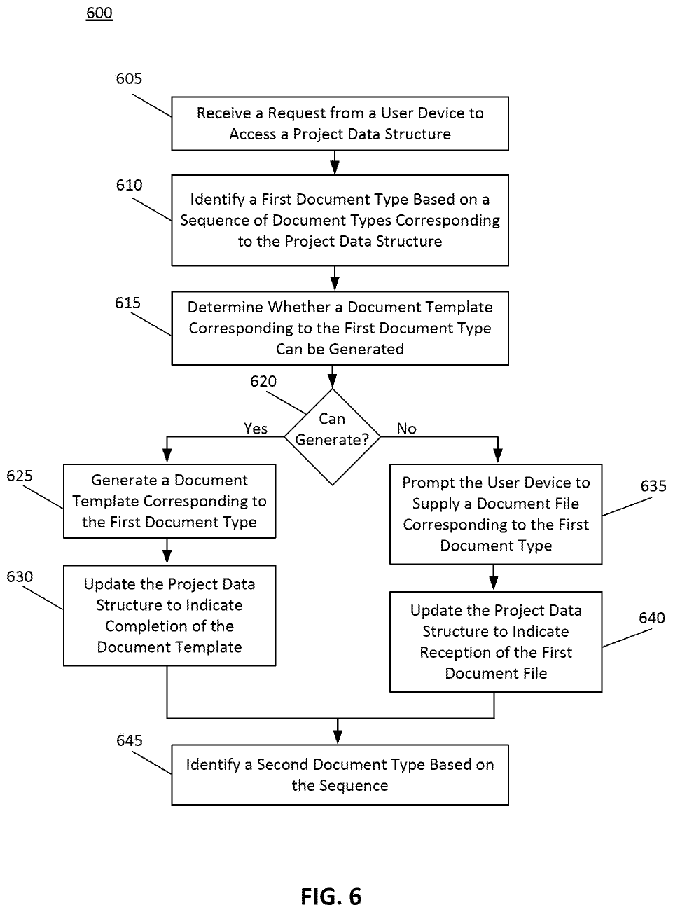

FIG. 6 depicts a flowchart illustrating a method 600 for updating a project data structure depending on a document type, according to some embodiments. Method 600 shall be described with reference to FIGS. 1, 4, and 5; however, method 600 is not limited to that example embodiment.

In an embodiment, smart drive system 110 may facilitate the completion of a project data structure by receiving and/or completing documents corresponding to the project data structure. Upon receiving and/or completing a document, smart drive system 110 may update the project data structure. While method 600 is described with reference to smart drive system 110, method 600 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof.

It is to be appreciated that not all steps may be needed to perform the disclosure provided herein. Further, some of the steps may be performed simultaneously, or in a different order than shown in FIG. 6, as will be understood by a person of ordinary skill in the art.

At 605, smart drive system 110 may receive a request from a user device 140 to access a project data structure. This request is similar to the request from 405 and 505 as described with reference to FIGS. 4 and 5 respectively. At 610, smart drive system 110 may identify a first document type based on a sequence of document types corresponding to the project data structure. This identification is similar to the request from 410 and 510 as described with reference to FIGS. 4 and 5 respectively. In an embodiment, the project data structure may include documents to be submitted by a user device 140 as well as documents generated by smart drive system 110 and to be completed by the user.

At 615, smart drive system 110 may determine whether a document template corresponding to the first document type can be generated. For example, smart drive system 110 may check a library or database of available document types for which it can generate a document template. In some embodiments, a user may restrict a project data structure to require the submission of document rather than allowing the use of a document template. In this case, smart drive system 110 may request a submission rather than provide a document template for a user to utilize. At 620, smart drive system 110 may determine whether to generate a document template.

If smart drive system 110 can generate a document template, smart drive system 110 may generate the document template corresponding to the first document type at 625. For example, smart drive system 110 may check a database to determine whether a document template exists. If so, similar to 515 and 520, a user may add data and/or modify the document template to complete the document. When the document is complete, smart drive system 110 may update the project data structure to indicate completion of the document template at 630. This update may be similar to 425 and 530 as described with reference to FIGS. 4 and 5 respectively.

If smart drive system 110 cannot generate a document template, smart drive system 110 may prompt the user device to supply a document file corresponding to the first document type at 635. Smart drive system 110 may not be able to generate a document template when checking a database and determining that one has not been stored. In response to determining that the database lacks the document template, smart drive system 110 may prompt the user device to supply the corresponding document file. Similar to 415 and 420, the user may supply the document to smart drive system 110. For example, a user device 140 may upload the document file, transmit the document file, and/or identify the document file in a cloud-based platform. Upon receiving the document, smart drive system 110 may update the project data structure to indicate reception of the first document file at 640. This update may be similar to 425 and 530 as described with reference to FIGS. 4 and 5 respectively.

At 645, smart drive system 110 may identify a second document type based on the sequence. This identification is similar to the identification from 430-435 and 535 as described with reference to FIGS. 4 and 5 respectively. In the case where the sequence includes documents that are generated by smart drive system 110 as well as documents that are supplied by the user, smart drive system 110 may iteratively perform method 600 until reception and/or completion of the documents listed in the project data structure.

To illustrate an example embodiment, a project data structure may include three document types in a sequence. The first and second document types may be submitted by a user while the third document type may be generated by smart drive system 110. In this case, smart drive system 110 may receive a request from a user device to access the project data structure, which identifies the sequence of document types. Smart drive system 110 may identify the first document type based on the sequence and prompt the user device to supply a first document file corresponding to the first document type. Smart drive system 110 may receive the first document file from the user device and update the project data structure to indicate reception of the first document file. Smart drive system 110 may identify a second document type based on the sequence and then prompt the user device to supply a second document file corresponding to the second document. In some embodiments, smart drive system 110 may execute method 600 to identify these documents.

When reaching the third document type of the sequence, smart drive system 110 may identify the presence of a document template corresponding to the third document type in a database. For example, smart drive system 110 may check the database to determine whether a document template corresponding to the third document type has been stored. If so, smart drive system 110 may generate a document template corresponding to the third document type. Smart drive system 110 may receive data from the user device corresponding to a field of the document template and update the document template with the data. Smart drive system 110 may then update the project data structure to indicate completion of the document template and the third document type. As previously explained, this process may occur iteratively until completion of the project, transaction, and/or process.

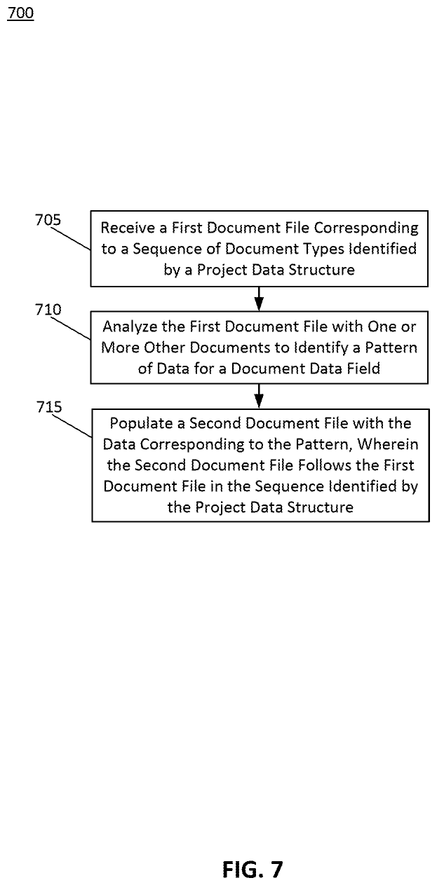

FIG. 7 depicts a flowchart illustrating a method 700 for propagating document data, according to some embodiments. Method 700 shall be described with reference to FIGS. 1, 4, 5, and 6; however, method 700 is not limited to that example embodiment.

In an embodiment, smart drive system 110 analyze received and/or completed documents to facilitate the creation of additional documents. Upon receiving and/or completing a document, smart drive system 110 may use machine learning, artificial intelligence, deep learning, neural networks, and/or other machine learning techniques to identify patterns of common data among the received or created documents. Smart drive system 110 may then include this data when creating new documents. While method 700 is described with reference to smart drive system 110, method 700 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof

It is to be appreciated that not all steps may be needed to perform the disclosure provided herein. Further, some of the steps may be performed simultaneously, or in a different order than shown in FIG. 7, as will be understood by a person of ordinary skill in the art.

At 705, smart drive system 110 may receive a first document file corresponding to a sequence of document types identified by a project data structure. This may be similar to 420 as described with reference to FIG. 4. In some embodiments, smart drive system 110 may have stored previously received and/or created documents corresponding to the project data structure. The first document file may be the first in a sequence and/or may be a subsequent file in the sequence.

At 710, smart drive system 110 may analyze the first document file with one or more other documents to identify a pattern of data for a document data field. As previously explained, smart drive system 110 may use machine learning, artificial intelligence, deep learning, neural networks, and/or other machine learning techniques to identify patterns of common data among the received or created documents. Smart drive system 110 may use computer vision and/or optical character recognition to identify common data. By using the project data structure, smart drive system 110 may identify the interconnectedness of the documents and may extract the common data. In some embodiments, when establishing the project data structure, a user may also identify common fields and/or data values corresponding to those fields for the project. For example, common fields may include party names, addresses, contact information, dates, and/or other information. These fields may be common between documents of the project. Smart drive system 110 may compare these fields and corresponding values with detected values from the first document file. For example, smart drive system 110 may identify content of the first document file that matches content of a previous document of the sequence. This matching content may be used at 715 when generating a subsequent document file.

Similarly, smart drive system 110 may manage the documents as they relate to the particular project, transaction, process, record, and/or lifestyle management of a “thing.” For example, the documents may relate to a particular person, property, animal, asset (e.g., boat, car, collectible artwork), and/or other objects. In this manner, the documents corresponding to the “thing” may be interconnected, which may provide a document of things or contract of things interconnectivity. The matching content may be common among the documents corresponding to the “thing.”

In some embodiments, smart drive system 110 may also identify any discrepancies or non-matching data. A user may then correct this non-matching data. In this case, smart drive system 110 may use the corrected data when generating a subsequent document file.

At 715, smart drive system 110 may populate a second document file with the data corresponding to the pattern, wherein the second document file follows the first document file in the sequence identified by the project data structure. Smart drive system 110 may populate this information when generating a subsequent document in the project. The second document file may be a different document type than the first document file.

In this manner, smart drive system 110 may analyze data, detect information common from multiple files, and generate new documents having this information even if the new document is of a different type. Smart drive system 110 may perform this population when executing 515 and/or 625 from methods 500 and 600 respectively. As other documents and/or document files are received or completed, smart drive system 110 may continue to analyze the new documents to identify new information and/or to update previously identified information. In this manner, smart drive system 110 may interconnect the documents and generate more accurate documents as the project, transaction, or process progresses.

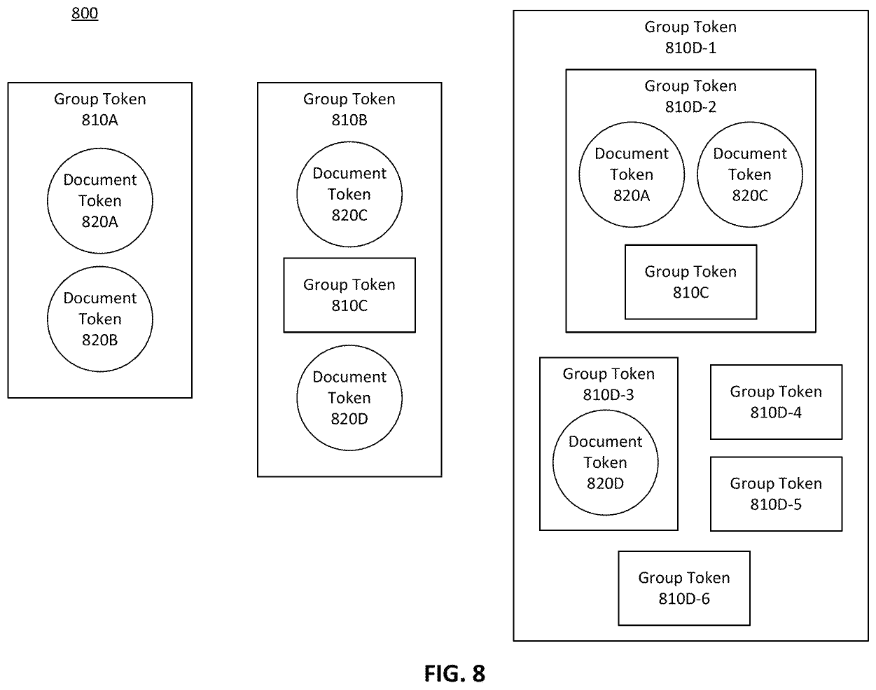

FIG. 8 depict a block diagram 800 depicting group tokens 810 and document tokens 820, according to some embodiments. Group tokens 810 and document tokens 820 may be generated to correspond to one or more project data structures as previously described. An example embodiment will be described with reference to FIG. 8 to describe the relationship between group tokens 810 and document tokens 820. Smart drive system 110 may manage the group tokens 810 and document tokens 820 for different users and/or parties. Smart drive system 110 may also apply hash algorithms to generate group tokens 810 and/or document tokens 820. Smart drive system 110 may manage digital wallets with these tokens to manage permissions related to the groups and/or documents.

In an embodiment, group tokens 810 may correspond to different aspects of a user

Mary progressing through a home purchase process. Group token 810A may be a group token corresponding to a project data structure corresponding to Mary's household documents. Group token 810B may correspond to a project data structure managed by Mary's bank. Group token 810D-1 may correspond to a project data structure managed by Mary's real estate agent.

Document tokens 820A and 820B correspond to group token 810A. Document tokens 820A and 820B may be personal records submitted by Mary. For example, document token 820A may correspond to Mary's driver's license while document token 820B may correspond to Mary's passport. Mary may have submitted these documents based on a sequence and/or without a sequence of documents. Smart drive system 110 may manage and/or tokenize these documents. Smart drive system 110 may also generate group token 810A corresponding to these documents.

Group token 810B may correspond to a project data structure managed by Mary's bank. Group token 810B may include document token 820C, which may be a loan application. The bank may have issued the loan application and may be the owner of document token 820C.

Group token 810B may also include group token 810C. Group token 810C may correspond to a mortgage prequalification process. Group token 810C may include access to the document applicable to this process. As will be further described below, group token 810C may be shared with Mary's real estate agent within group token 810D-2.

Group token 810B may also include document token 820D. As will be further described below, document token 820D may be a shared document token with group token 810D-1. For example, document token 820D may correspond to a real estate sales contract. In this case, the bank as well as Mary's real estate agent may have permissions corresponding to the real estate sales contract. Depending on these permissions, the bank may be restricted to viewing the contract. Access to document token 820D, however, may allow the bank to confirm the execution of the contract.

Similar to the bank, Mary's real estate agent may manage group token 810D-1 corresponding to the real estate purchase process. Smart drive system 110 may identify permissions based on the group tokens 810 and/or document tokens 820. Group token 810D-1 may include group token 810D-2. This may present a hierarchy or nesting of group tokens 810. The hierarchy and/or nesting may represent sub-processes for an overall process. For example, group token 810D-2 may be part of the process of negotiation and may include the offer and acceptance aspect of the property purchase. Group token 810D-2 may include document token 820A, document token 820C, and/or group token 810C. These may correspond to Mary's driver's license, Mary's mortgage prequalification, and/or the group of documents corresponding to Mary's mortgage prequalification process. Group token 810D-2 may organize these tokens and/or permissions corresponding to these tokens. Group token 810D-1 may also include group token 810D-3, which may correspond to the sales portion of the property purchase. Group token 810D-3 may include document token 820D, which may correspond to the real estate sales contract. As previously explained, access to document token 820D may be shared with the bank managing group token 810B. In some embodiments, Mary's real estate agent may be provided permission to view the document based on document token 820D from an external issuer, such as Mary's law firm.

Group token 810D-1 may also include other group tokens 810D-4, 810D-5, and 810D-6. These group tokens may correspond to mortgage documents, title documents, and/or closing documents. In this manner, smart drive system 110 may manage document tokens 820 as well as group tokens 810 for different entities. Smart drive system 110 may also manage permissions, such as modification and/or viewing permissions, for the entities. By managing the documents and/or tokens using blockchain 120 and property of immutability, smart drive system 110 may maintain a “single source of truth” that entities may rely upon. In this manner, smart drive system 110 may streamline document and/or group management in a more trusted manner.

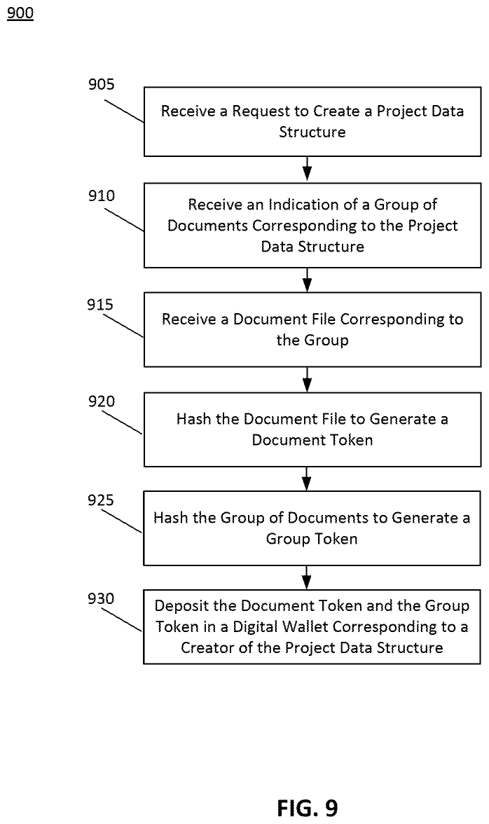

FIG. 9 depicts a flowchart illustrating a method 900 for generating a group token, according to some embodiments. Method 900 shall be described with reference to FIG. 1; however, method 900 is not limited to that example embodiment.

In an embodiment, smart drive system 110 may facilitate the generation of group and/or document tokens, which may correspond to a project data structure. While method 900 is described with reference to smart drive system 110, method 900 may be executed on any computing device, such as, for example, the computer system described with reference to FIG. 10 and/or processing logic that may comprise hardware (e.g., circuitry, dedicated logic, programmable logic, microcode, etc.), software (e.g., instructions executing on a processing device), or a combination thereof

It is to be appreciated that not all steps may be needed to perform the disclosure provided herein. Further, some of the steps may be performed simultaneously, or in a different order than shown in FIG. 9, as will be understood by a person of ordinary skill in the art.

At 905, smart drive system 110 may receive a request to create a project data structure. For example, a user device 140 may provide a command via a user interface 130 to smart drive system 110. A user may navigate a GUI to indicate the creation of a project data structure. This project data structure may correspond to a project, transaction, and/or process. The project data structure may be metadata, which indicates list of documents, document types, folders, and/or groups. The project data structure may include groupings of documents which may or may not include a sequence of documents. In some embodiments, the project data structure may not include any sequence.

At 910, smart drive system 110 may receive an indication of a group of documents corresponding to the project data structure. This group of documents may be similar to those described with reference to FIG. 8. The indication of the group of documents may correspond to the entirety of the project data structure and/or may be a portion of the project data structure. The group of documents may be sequenced and/or may not be sequenced. When the group of documents is a portion of a project data structure, the group of documents may or may not be sequenced with other groups and/or documents.

At 915, smart drive system 110 may receive a document file corresponding to the group. This document file and/or document data may be submitted to the group and/or completed based on a template provided by smart drive system 110. In some embodiments, smart drive system 110 may receive a document file corresponding to the group.

At 920, smart drive system 110 may hash the document file to generate a document token. Smart drive system 110 may generate a document token corresponding to the document by applying a hash algorithm to the document. The hash algorithm may be a cryptographic hashing algorithm. This hash may provide confidentiality related to the document. The document token may also indicate permissions as previously described based on ownership of the document token in a digital wallet. For example, these permissions may include restricting access to only viewing the document.

At 925, smart drive system 110 may hash the group of documents to generate a group token. Smart drive system 110 may generate a group token corresponding to the group by applying a hash algorithm to documents of the group. This hash algorithm may be the same or different from the hash algorithm applied to the document. The generation of the group token may allow for a sharing of permissions similar to the document token. For example, providing the group token may allow viewing permissions for the documents in the group. Based on the management of the documents on blockchain 120, users may reliably depend on the documents when accessing them using the group token.

At 930, smart drive system 110 may deposit the document token and the group token in a digital wallet corresponding to a creator of the project data structure. By depositing these tokens in the digital wallet, the creator may access, modify, manage, and/or view the document and/or group. Smart drive system 110 may also update the project data structure to mark a submission of the document and/or a completion of the documents in the group. Smart drive system 110 may prompt the user to submit additional documents and/or indicate a completion of the project data structure. Similarly, the creator may share the document token and/or the group token with other parties. This sharing may indicate the submission or completion of the document and/or group of documents. The other parties may use these tokens to indicate a submission or completion corresponding to their own project data structures. Smart drive system 110 may identify and/or update these project data structures as well.

Various embodiments may be implemented, for example, using one or more well-known computer systems, such as computer system 1000 shown in FIG. 10. One or more computer systems 1000 may be used, for example, to implement any of the embodiments discussed herein, as well as combinations and sub-combinations thereof

Computer system 1000 may include one or more processors (also called central processing units, or CPUs), such as a processor 1004. Processor 1004 may be connected to a communication infrastructure or bus 1006.

Computer system 1000 may also include user input/output device(s) 1003, such as monitors, keyboards, pointing devices, etc., which may communicate with communication infrastructure 1006 through user input/output interface(s) 1002.

One or more of processors 1004 may be a graphics processing unit (GPU). In an embodiment, a GPU may be a processor that is a specialized electronic circuit designed to process mathematically intensive applications. The GPU may have a parallel structure that is efficient for parallel processing of large blocks of data, such as mathematically intensive data common to computer graphics applications, images, videos, etc.

Computer system 1000 may also include a main or primary memory 1008, such as random access memory (RAM). Main memory 1008 may include one or more levels of cache. Main memory 1008 may have stored therein control logic (i.e., computer software) and/or data.

Computer system 1000 may also include one or more secondary storage devices or memory 1010. Secondary memory 1010 may include, for example, a hard disk drive 1012 and/or a removable storage device or drive 1014. Removable storage drive 1014 may be a floppy disk drive, a magnetic tape drive, a compact disk drive, an optical storage device, tape backup device, and/or any other storage device/drive.

Removable storage drive 1014 may interact with a removable storage unit 818. Removable storage unit 1018 may include a computer usable or readable storage device having stored thereon computer software (control logic) and/or data. Removable storage unit 1018 may be a floppy disk, magnetic tape, compact disk, DVD, optical storage disk, and/ any other computer data storage device. Removable storage drive 1014 may read from and/or write to removable storage unit 1018.

Secondary memory 1010 may include other means, devices, components, instrumentalities or other approaches for allowing computer programs and/or other instructions and/or data to be accessed by computer system 1000. Such means, devices, components, instrumentalities or other approaches may include, for example, a removable storage unit 1022 and an interface 1020. Examples of the removable storage unit 1022 and the interface 1020 may include a program cartridge and cartridge interface (such as that found in video game devices), a removable memory chip (such as an EPROM or PROM) and associated socket, a memory stick and USB port, a memory card and associated memory card slot, and/or any other removable storage unit and associated interface.

Computer system 1000 may further include a communication or network interface 1024. Communication interface 824 may enable computer system 1000 to communicate and interact with any combination of external devices, external networks, external entities, etc. (individually and collectively referenced by reference number 1028). For example, communication interface 1024 may allow computer system 1000 to communicate with external or remote devices 1028 over communications path 1026, which may be wired and/or wireless (or a combination thereof), and which may include any combination of LANs, WANs, the Internet, etc. Control logic and/or data may be transmitted to and from computer system 1000 via communication path 1026.

Computer system 1000 may also be any of a personal digital assistant (PDA), desktop workstation, laptop or notebook computer, netbook, tablet, smart phone, smart watch or other wearable, appliance, part of the Internet-of-Things, and/or embedded system, to name a few non-limiting examples, or any combination thereof

Computer system 1000 may be a client or server, accessing or hosting any applications and/or data through any delivery paradigm, including but not limited to remote or distributed cloud computing solutions; local or on-premises software (“on-premise” cloud-based solutions); “as a service” models (e.g., content as a service (CaaS), digital content as a service (DCaaS), software as a service (SaaS), managed software as a service (MSaaS), platform as a service (PaaS), desktop as a service (DaaS), framework as a service (FaaS), backend as a service (BaaS), mobile backend as a service (MBaaS), infrastructure as a service (IaaS), etc.); and/or a hybrid model including any combination of the foregoing examples or other services or delivery paradigms.

Any applicable data structures, file formats, and schemas in computer system 1000 may be derived from standards including but not limited to JavaScript Object Notation (JSON), Extensible Markup Language (XML), Yet Another Markup Language (YAML), Extensible Hypertext Markup Language (XHTML), Wireless Markup Language (WML), MessagePack, XML User Interface Language (XUL), or any other functionally similar representations alone or in combination. Alternatively, proprietary data structures, formats or schemas may be used, either exclusively or in combination with known or open standards.

In some embodiments, a tangible, non-transitory apparatus or article of manufacture comprising a tangible, non-transitory computer useable or readable medium having control logic (software) stored thereon may also be referred to herein as a computer program product or program storage device. This includes, but is not limited to, computer system 1000, main memory 1008, secondary memory 1010, and removable storage units 1018 and 1022, as well as tangible articles of manufacture embodying any combination of the foregoing. Such control logic, when executed by one or more data processing devices (such as computer system 1000), may cause such data processing devices to operate as described herein.

Based on the teachings contained in this disclosure, it will be apparent to persons skilled in the relevant art(s) how to make and use embodiments of this disclosure using data processing devices, computer systems and/or computer architectures other than that shown in FIG. 10. In particular, embodiments can operate with software, hardware, and/or operating system implementations other than those described herein.

It is to be appreciated that the Detailed Description section, and not any other section, is intended to be used to interpret the claims. Other sections can set forth one or more but not all exemplary embodiments as contemplated by the inventor(s), and thus, are not intended to limit this disclosure or the appended claims in any way.

While this disclosure describes exemplary embodiments for exemplary fields and applications, it should be understood that the disclosure is not limited thereto. Other embodiments and modifications thereto are possible, and are within the scope and spirit of this disclosure. For example, and without limiting the generality of this paragraph, embodiments are not limited to the software, hardware, firmware, and/or entities illustrated in the figures and/or described herein. Further, embodiments (whether or not explicitly described herein) have significant utility to fields and applications beyond the examples described herein.

Embodiments have been described herein with the aid of functional building blocks illustrating the implementation of specified functions and relationships thereof. The boundaries of these functional building blocks have been arbitrarily defined herein for the convenience of the description. Alternate boundaries can be defined as long as the specified functions and relationships (or equivalents thereof) are appropriately performed. Also, alternative embodiments can perform functional blocks, steps, operations, methods, etc. using orderings different than those described herein.

References herein to “one embodiment,” “an embodiment,” “an example embodiment,” or similar phrases, indicate that the embodiment described can include a particular feature, structure, or characteristic, but every embodiment can not necessarily include the particular feature, structure, or characteristic. Moreover, such phrases are not necessarily referring to the same embodiment. Further, when a particular feature, structure, or characteristic is described in connection with an embodiment, it would be within the knowledge of persons skilled in the relevant art(s) to incorporate such feature, structure, or characteristic into other embodiments whether or not explicitly mentioned or described herein. Additionally, some embodiments can be described using the expression “coupled” and “connected” along with their derivatives. These terms are not necessarily intended as synonyms for each other. For example, some embodiments can be described using the terms “connected” and/or “coupled” to indicate that two or more elements are in direct physical or electrical contact with each other. The term “coupled,” however, can also mean that two or more elements are not in direct contact with each other, but yet still co-operate or interact with each other.

The breadth and scope of this disclosure should not be limited by any of the above-described exemplary embodiments, but should be defined only in accordance with the following claims and their equivalents.

1-20. (canceled)

21. A computer implemented method, comprising:
receiving a request from a user device to access a first project data structure identifying a sequence of document types;
identifying a first document type based on the sequence;
prompting the user device to supply a first document file corresponding to the first document type;
receiving the first document file from the user device;
updating the first project data structure to indicate reception of the first document file;
identifying a second document type based on the sequence;
prompting the user device to supply a second document file corresponding to the second document type;
receiving the second document file from the user device;
updating the first project data structure to indicate reception of the second document file;
hashing the second document file to generate a document token indicating an access permission corresponding to the second document file;
receiving a command from the user device to associate the second document file with a second project data structure differing from the first project data structure; and
updating the second project data structure to include the document token, wherein accessing the second document file via the second project data structure occurs based on the access permission corresponding to the document token.

22. The computer implemented method of claim 1, further comprising:
identifying a third document type based on the sequence;
generating a document template corresponding to the third document type;
receiving data from the user device corresponding to a field of the document template;
updating the document template with the data; and
updating the first project data structure to indicate completion of the document template.

23. The computer implemented method of claim 2, further comprising:
receiving a modification of the document template from a second user device;
notifying the user device of the modification; and
updating the first project data structure in response to receiving a command accepting the modification from the user device.

24. The computer implemented method of claim 1, wherein the first document type corresponds to a group of documents, the method further comprising:
hashing the first document file to generate a document token;
hashing the group of documents to generate a group token; and
depositing the document token and the group token in a digital wallet corresponding to a creator of the first project data structure.

25. The computer implemented method of claim 1, further comprising:
identifying content of the first document file that matches content of a previous document file of the sequence; and
generating a third document file including the content.

26. The computer implemented method of claim 1, further comprising:
determining whether a document template corresponding to the second document type has been stored in a database; and
in response to determining that the database lacks the document template, prompting the user device to supply the second document file corresponding to the second document type.

27. The computer implemented method of claim 1, wherein receiving the first document file further comprises:
receiving, via cloud computing platform, a designation of the document file.

28. A system, comprising:
a memory; and
at least one processor coupled to the memory and configured to:
receive a request from a user device to access a first project data structure identifying a sequence of document types;
identify a first document type based on the sequence;
prompt the user device to supply a first document file corresponding to the first document type;
receive the first document file from the user device;
update the first project data structure to indicate reception of the first document file;
identify a second document type based on the sequence;
prompt the user device to supply a second document file corresponding to the second document type;
receive the second document file from the user device;
update the first project data structure to indicate reception of the second document file;
hash the second document file to generate a document token indicating an access permission corresponding to the second document file;
receive a command from the user device to associate the second document file with a second project data structure differing from the first project data structure; and
update the second project data structure to include the document token, wherein accessing the second document file via the second project data structure occurs based on the access permission corresponding to the document token.

29. The system of claim 8, wherein the at least one processor is further configured to:
identify a third document type based on the sequence;
generate a document template corresponding to the third document type;
receive data from the user device corresponding to a field of the document template;
update the document template with the data; and
update the first project data structure to indicate completion of the document template.

30. The system of claim 9, wherein the at least one processor is further configured to:
receive a modification of the document template from a second user device;
notify the user device of the modification; and
update the first project data structure in response to receiving a command accepting the modification from the user device.

31. The system of claim 8, wherein the first document type corresponds to a group of documents and wherein the at least one process is further configured to:
hash the first document file to generate a document token;
hash the group of documents to generate a group token; and
deposit the document token and the group token in a digital wallet corresponding to a creator of the first project data structure.

32. The system of claim 8, wherein the at least one process is further configured to:
identify content of the first document file that matches content of a previous document file of the sequence; and
generate a third document file including the content.

33. The system of claim 8, wherein the at least one processor is further configured to:
determine whether a document template corresponding to the second document type has been stored in a database; and
in response to determining that the database lacks the document template, prompt the user device to supply the second document file corresponding to the second document type.

34. The system of claim 8, wherein to receive the first document file, the at least one processor is further configured to:
receive, via cloud computing platform, a designation of the document file.

35. A non-transitory computer-readable device having instructions stored thereon that, when executed by at least one computing device, cause the at least one computing device to perform operations comprising:
receiving a request from a user device to access a first project data structure identifying a sequence of document types;
identifying a first document type based on the sequence;
prompting the user device to supply a first document file corresponding to the first document type;
receiving the first document file from the user device;
updating the first project data structure to indicate reception of the first document file;
identifying a second document type based on the sequence;
prompting the user device to supply a second document file corresponding to the second document type;
receiving the second document file from the user device;
updating the first project data structure to indicate reception of the second document file;
hashing the second document file to generate a document token indicating an access permission corresponding to the second document file;
receiving a command from the user device to associate the second document file with a second project data structure differing from the first project data structure; and
updating the second project data structure to include the document token, wherein accessing the second document file via the second project data structure occurs based on the access permission corresponding to the document token.

36. The non-transitory computer-readable device of claim 15, the operations further comprising:
identifying a third document type based on the sequence;
generating a document template corresponding to the third document type;
receiving data from the user device corresponding to a field of the document template;
updating the document template with the data; and
updating the first project data structure to indicate completion of the document template.

37. The non-transitory computer-readable device of claim 16, the operations further comprising:
receiving a modification of the document template from a second user device;
notifying the user device of the modification; and
updating the first project data structure in response to receiving a command accepting the modification from the user device.

38. The non-transitory computer-readable device of claim 15, wherein the first document type corresponds to a group of documents, the operations further comprising:
hashing the first document file to generate a document token;
hashing the group of documents to generate a group token; and
depositing the document token and the group token in a digital wallet corresponding to a creator of the first project data structure.

39. The non-transitory computer-readable device of claim 15, the operations further comprising:
identifying content of the first document file that matches content of a previous document file of the sequence; and
generating a third document file including the content.

40. The non-transitory computer-readable device of claim 15, the operations further comprising:
determining whether a document template corresponding to the second document type has been stored in a database; and
in response to determining that the database lacks the document template, prompting the user device to supply the second document file corresponding to the second document type.
